(19) United States
(12) Patent Application Publication
(10) Pub. No.: US 2004/0257744 A1
(43) Pub. Date: Dec. 23, 2004

(54) Collision avoidance system and method

(76) Inventors: Wit Cezary Bushko, Niskayuna, NY (US); Sreeganesh Ramaswamy, Menomonee Falls, WI (US)

Correspondence Address: Patrick S. Yoder, FLETCHER YODER, P.O. Box 692289, Houston, TX, 77269-2289, US

(21) Appl. No.: 10/601,715

(22) Filed: Jun. 23, 2003

(51) Int. Cl. H01H 47/12

(52) U.S. Cl. 361/179; 340/686.1

(57) ABSTRACT

A collision avoidance system for sensing a presence of objects within a critical distance is provided. The system comprises a collision avoidance array disposed on a face of the system component, the collision avoidance array comprising a plurality of plates configured to detect a presence of objects and generate a corresponding electrical signal. In addition, the system further comprises a multiplexer configured to selectively couple the plurality of plates to a sensing circuit. The sensing circuit configured to sense the electrical signal and generate a corresponding electric field around the collision avoidance array to prevent the object from colliding with the system sub-component.

### BACKGROUND OF THE INVENTION

The invention relates generally to detection systems, and more specifically to a system and method for detecting objects and avoiding collision with system subcomponents.

In many applications, such as imaging systems used in the medical field, detection circuits are used for sensing the presence of objects and avoiding the objects from colliding with sub-components of the imaging system. The objects may vary from patients being imaged to operators operating the system. Another application of such detection circuits is in patient anatomical profiling, where it is necessary to maintain a constant distance between an X-ray detector, for example, and the external anatomical contour of the patient.

For applications such as in X-ray imaging systems, it is desirable to maintain a uniform of electric field around the detector surface. In addition, the sensitivity of the field is generally required to be maintained so as gauge a well-defined cut-off distance that is dictated when a collision becomes imminent. It is desirable to design a detection system such that the system can detect objects of varying sizes. For example, the detection system should be able to distinguish between small objects at a closer proximity from the detector versus larger objects at a farther proximity.

It is also desirable to ensure that there is no interference between the detection system and the electronics in the X-ray detector. Also, care is generally taken to ensure that the detection system does not reduce the transmissibility of X-rays. Existing systems however do not provide collision detection around the detector and is generally restricted to the edge of the source of the imaging system.

It would therefore be desirable to design a collision avoidance system to ensure that objects of varying sizes are detected and prevented from colliding with a system subcomponent while maintaining the uniqueness and the sensitivity of the field around the subcomponent.

### BRIEF DESCRIPTION OF THE INVENTION

Briefly, in accordance with one aspect of the present technique, an imaging system for sensing a presence of objects within a critical distance is provided. The imaging system comprises a source configured for emitting a stream of radiation, a detector configured for detecting a portion of radiation and impacting a detecting face of the detector, and a collision avoidance array disposed on the detecting face of the detector and configured for sensing objects within the critical distance.

The present technique also provides a collision avoidance system for avoiding collision of a system component with objects is provided. The system comprises a collision avoidance array disposed on a face of the system component, the collision avoidance array comprising a plurality of plates configured to detect a presence of objects and generate a corresponding electrical signal. In addition, the system further comprises a multiplexer coupled to the collision avoidance array, the multiplexer configured to selectively couple the plurality of plates to a sensing circuit. The sensing circuit configured to sense the electrical signal and generate a corresponding electric field around the collision avoidance array to prevent the object from colliding with the system sub-component.

In a further embodiment, a detection system for detecting a presence of objects is provided. The detection system comprises a plurality of sensors disposed on a substrate substantially on one plane, each of the plurality of sensors configured for detecting the presence of the object and generating a corresponding electrical signal. In addition, a plurality of conductors extending substantially on the plane and coupled to a corresponding one of the plurality of sensors, each conductor configured to transmit the electrical signal when the object is detected.

The present technique also provides a system for avoiding collision of a system component with an object is provided. The technique comprises detecting a presence of the object within a critical distance from a face of the system component and generating a corresponding electrical signal. Further, the technique comprises generating an electrical field around the system component when the electrical signal is received.

In another embodiment a system for avoiding collision of a system component with an object is provided. The system comprises a means for detecting a presence of the object within a critical distance from a face of the system component and generating a corresponding electrical signal and a means for generating an electrical field around the system component when the electrical signal is received.

### BRIEF DESCRIPTION OF THE DRAWINGS

The foregoing and other advantages and features of the invention will become apparent upon reading the following detailed description and upon reference to the drawings in which:

FIG. 1 is a diagrammatic view of an exemplary imaging system suitable for implementation of a collision avoidance array;

FIG. 2 is a diagrammatic view of an imaging system implemented according to an aspect of the invention;

FIG. 3 is a perspective view of an exemplary collision avoidance array implemented according to an aspect of the invention;

FIG. 4 is a side view of the collision avoidance array of FIG. 3 disposed on a detector;

FIG. 5 is a top view of an exemplary collision avoidance array illustrating one manner in which individual sensors of the array is multiplexed;

FIG. 6 is a top view of an exemplary collision avoidance array in which dedicated traces are included for shielding the sensors of the array; and

FIG. 7 is a flow chart illustrating an exemplary method by which objects within a critical distance are detected by virtue of a collision avoidance array.

### DETAILED DESCRIPTION OF SPECIFIC EMBODIMENTS

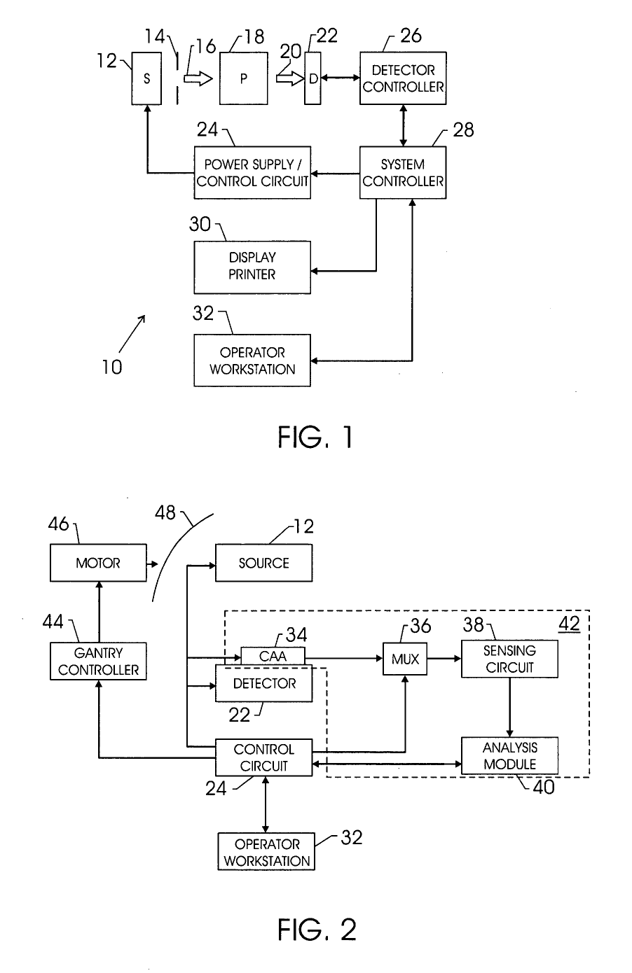

FIG. 1 illustrates diagrammatically an imaging system 10 for acquiring and processing discrete pixel image data. In the illustrated embodiment, system 10 is a digital X-ray system designed both to acquire original image data, and to process the image data for display in accordance with the present technique. In the embodiment illustrated in FIG. 1, imaging system 10 includes a source of X-ray radiation 12 positioned adjacent to a collimator 14. Collimator 14 permits a stream of radiation 16 to pass into a region in which a subject, such as a human patient 18 is positioned. A portion of the radiation 20 passes through or around the subject and impacts a digital X-ray detector, represented generally at reference numeral 22. Detector 22 converts the X-ray photons received on its surface to lower energy photons, and subsequently to electric signals that are acquired and processed to reconstruct an image of the features within the subject.

Source 12 is controlled by a power supply/control circuit 24 which furnishes both power and control signals for examination sequences. Moreover, detector 22 is coupled to a detector controller 26 that commands acquisition of the signals generated in the detector. Detector controller 26 may also execute various signal processing and filtration functions, such as for initial adjustment of dynamic ranges, interleaving of digital image data, and so forth. Both power supply/control circuit 24 and detector controller 26 are responsive to signals from a system controller 28. In general, system controller 28 commands operation of the imaging system to execute examination protocols and to process acquired image data. In the present context, system controller 28 also includes signal processing circuitry, typically based upon a general purpose or application-specific digital computer, associated memory circuitry for storing programs and routines executed by the computer, as well as configuration parameters and image data, interface circuits, and so forth.

In the embodiment illustrated in FIG. 1, system controller 28 is linked to at least one output device, such as a display or printer as indicated at reference numeral 30. The output device may include standard or special purpose computer monitors and associated processing circuitry. One or more operator workstations 32 may be further linked in the system for outputting system parameters, requesting examinations, viewing images, and so forth. In general, displays, printers, workstations, and similar devices supplied within the system may be local to the data acquisition components, or may be remote from these components, such as elsewhere within an institution or hospital, or in an entirely different location, linked to the image acquisition system via one or more configurable networks, such as the Internet, virtual private networks, and so forth.

Imaging system 10 further comprises collision avoidance system 42 as illustrated in FIG. 2. Collision avoidance system 42 comprises collision avoidance array 34, multiplexer 36, sensing circuit 38 and analysis module 40. In the illustrated embodiment, collision avoidance array 34 is disposed on a radiation detecting face of detector 22. It has been found that the materials used for implementing the collision avoidance array are substantially transparent to x-ray radiation and thus do not interfere with the operation of the other components of the imaging system. The collision avoidance array comprises a plurality of sensors configured to detect a presence of objects within a critical distance from the detector. In one embodiment, the critical distance for each one of the sensors is determined by a corresponding dimension of the sensor. In an embodiment, the critical distance is constant for all sensors. The collision avoidance array generates a corresponding electrical signal upon detection of an object. In an embodiment, the plurality of sensors comprises capacitive sensors. By virtue of the division of the sensor area into an array of sensors, large and small objects can be detected.

Multiplexer 36 is coupled to the collision avoidance array and is configured to selectively couple the plurality of plates in the collision avoidance array to sensing circuit 38. The sensing circuit is configured to sense the electrical signal and generate a corresponding electric field around the detector to prevent the object from colliding with the detector or any other part of the imaging system.

The sensing circuit is coupled to analysis module 40. In one embodiment, the analysis module is configured to determine a size of the object detected by the collision avoidance array. In another embodiment, the analysis module is configured to determine a distance of the object from the collision avoidance array based on the size of the object. 17.

Operator workstation 32 is configured to control the motion of gantry 48. The motion of the gantry is controlled using gantry controller 44 and motor 46. When the control circuit 24 receives a signal from sensing circuit 38 indicating the detection of an object within a critical distance of the detector, the control circuit controls the motion of the gantry to avoid collision with the detected object. In one embodiment, control circuit 24 may stop or even reverse the motion of the gantry to avoid collision of the detector with the detected object, overriding where desired, input commands from operator workstation 32.

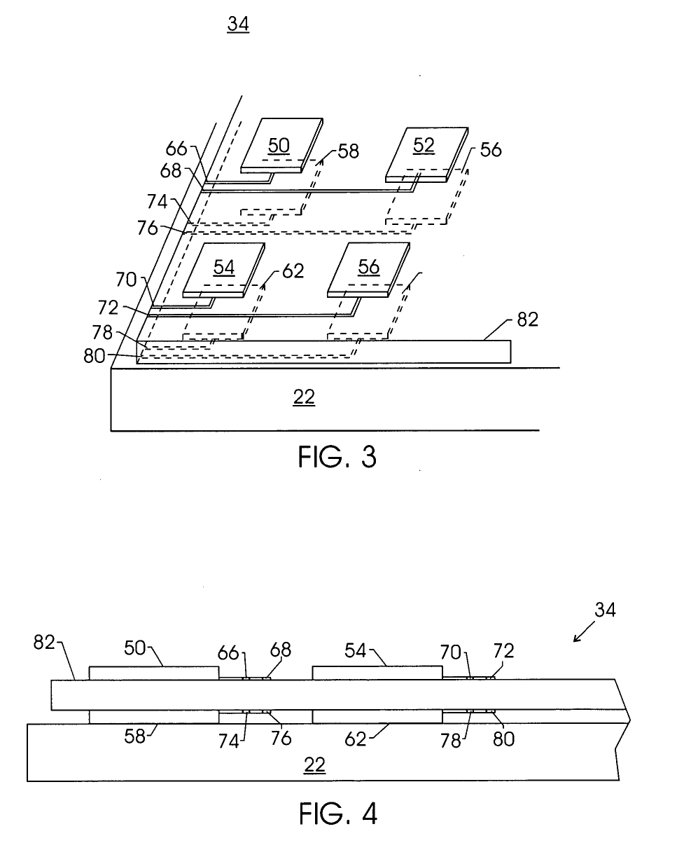

The collision avoidance array may be disposed on a non-detecting face of detector 22. By disposing the collision avoidance array around the detector, objects within a critical distance from non-detecting faces of the detector can also be prevented from colliding with the detector. The manner in which the collision avoidance array is implemented is described in detail with respect to FIG. 3.

FIG. 3 is a perspective view of the collision avoidance array 34 disposed on detector 22 of imaging system 10. Collision avoidance array 34 includes a plurality of plates 50, 52, 54, 56 disposed on the array substantially in a first plane. The array also comprises a plurality of plates 58, 60, 62 and 64 disposed substantially on a second plane. The plates on the first plane together with the plates on the second plane together form an array of capacitors. Each plate configured to sense objects at a corresponding critical distance and configured to generate a corresponding electrical signal. In one embodiment, the capacitor plates are made of aluminum.

Collision avoidance array 34 also comprises a plurality of conductors 66, 68, 70 and 72 extending substantially in the first plane and 74, 76, 78 and 80 extending substantially in the second plane. Each conductor is coupled to a corresponding one of the plurality of plates. For example, conductors 66, 68, 70 and 72 are coupled to plates 50, 52, 54 and 56 respectively. Similarly, conductors 74, 76, 78 and 80 are coupled to plates 58, 60, 62 and 64 respectively.

FIG. 4 is a side view of the collision avoidance array of FIG. 3 disposed on detector 22. The plurality of plates and the plurality of conductors are disposed on substrate 82. In one embodiment, the substrate comprises an insulator. Each pair of plates like plates 50 and 58 together comprises a capacitor. Similarly, plates 54 and 62 comprise another capacitor. Thus, the plurality of plates on the first plane and the plurality of plates in the second plane form an array of capacitors.

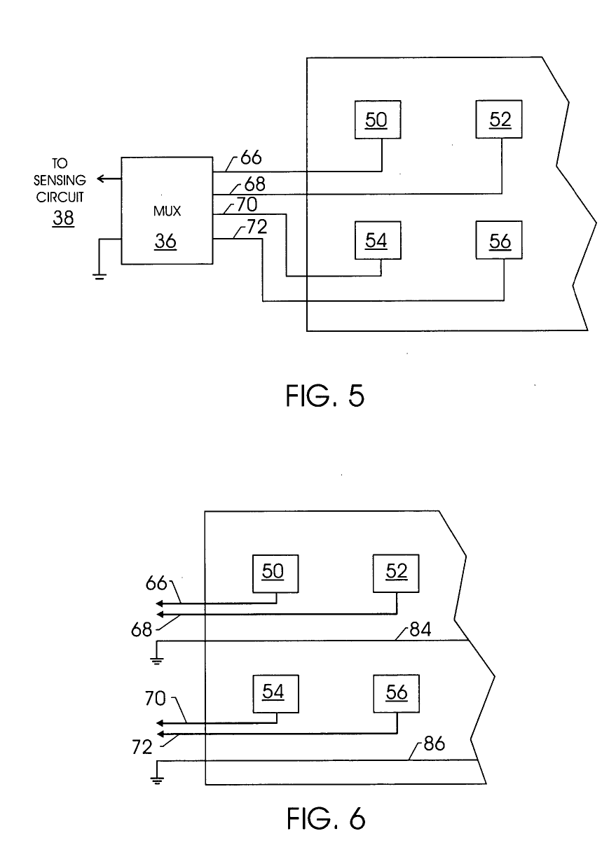

Each one of the plurality of conductors extending in the first plane as well as those extending in the second plane is coupled to multiplexer 36. FIG. 5 illustrates a portion of the collision avoidance array in which conductors 66, 68, 70 and 72 are coupled to plates 50, 52, 54 and 56, respectively, and are further coupled to multiplexer 36. The operation of the collision avoidance array is described in detail below.

Each plate of the collision avoidance array is configured for detecting objects within a critical distance from the array. When an object is detected by a plate, the corresponding plate is activated and generates an electrical signal. The corresponding conductor conducts the electrical signal coupled to the plate to sensing circuit 38 via multiplexer 36. In one embodiment, the sensing circuit generates and electric field around detector 22. Approaching objects perturb the electrical field and therefore change the charge on the sensors. The change in the charge of the sensors can be detected and can thus be attributed to the presence of objects within a pre-determined proximity of the detector.

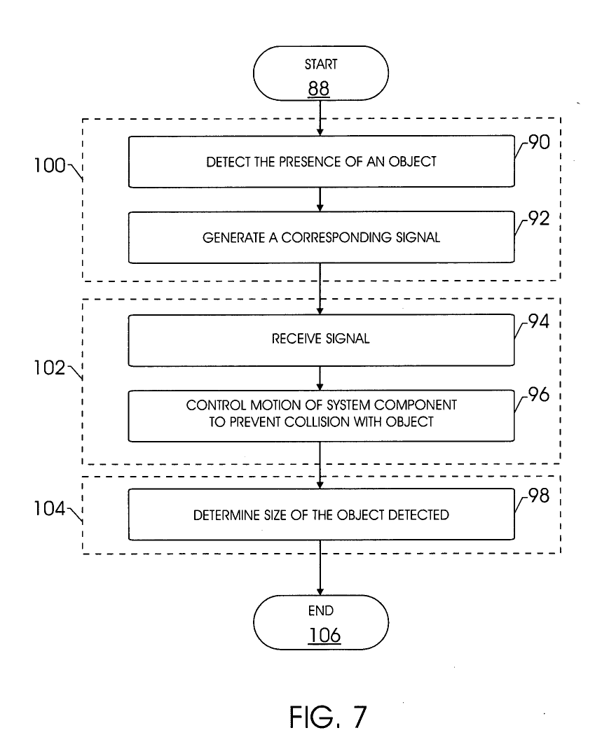

In one embodiment, at least one of the plurality of conductors is coupled to ground to provide shielding for the other conductors when any one of the capacitive sensor is activated. As will be appreciated by those skilled in the art, the grounding can be accomplished by the multiplexer. In another embodiment, as shown in FIG. 6, the collision avoidance array 34 also includes shielding conductor 84 and 86 extending substantially in one or both planes of the array. The shielding conductor is coupled to ground and is configured for providing shielding to at least one of the plurality of conductors when any one of the other capacitive sensors is activated. The method in which the collision avoidance array operates along with the sensing circuit and the analysis module is described in further detail in FIG. 7.

FIG. 7 is a flow chart illustrating a method in which collision avoidance system 42 of FIG. 2 operates to prevent objects from colliding into a system component. The method comprises three portions, namely the detecting portion 100, the controlling portion 102 and the analyzing portion 104. Where desired, the detecting portion may be provided without the controlling portion and the analyzing portion. Similarly, the controlling portion may be provided without the detecting portion and the analyzing portion. The method begins in step 88 and control passes over to step 90. Each step is described in further detail below.

The detecting portion 100 comprises steps 90 and 92 respectively. In step 90, a presence of the object within a critical distance is detected from a face of the system component. In the embodiment illustrated in FIG. 2, objects are detected by collision avoidance array 34. In step 92, a corresponding electrical signal is generated when the object is detected. For example, one of the plurality of plates in the collision avoidance array gets activated by the multiplexer and generates a corresponding electrical signal when the object is detected. During the process, multiple plates can be activated and the multiplexer can poll the plates in any desired pattern so that large and small objects can be detected. As described in the above sections, the multiplexer can also ground specific conductors to provide shielding to the other conductors in the array.

The controlling portion 102 comprises step 94 and 96 respectively. In step 94, the electrical signal generated in step 92 is received, the electrical signal being representative of the object detected. In the collision avoidance system 42, the sensing circuit receives the electrical signal via the multiplexer. In one embodiment, the sensing circuit propagates the electrical signal to control circuit 24 or analysis module 40. In step 96, the motion of system sub-component is controlled. In one embodiment, the control circuit 24 controls the motion of the gantry when the electrical signal indicating a detected object, is received.

The analyzing portion 102 comprises step 98. In step 98, a size of the object detected is determined. In the illustrated embodiment of FIG. 2, the analysis module determines the size of the object detected by determining the number of plates activated. In addition, the analysis module can also determine the configuration of the detected object. In another embodiment, the distance of the object from the detector is determined using the size of the object.

The previously described embodiments of the invention have many advantages, such as being able to detect any object within a critical distance, irrespective of the size of the object, due to the presence-of the plurality of sensors in the array. Thus, by virtue of the division of the sensor area into an array of sensors, enhanced functionality of the collision avoidance array is accomplished because large and small objects can be detected.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. An imaging system for sensing a presence of objects near the imaging system, the imaging system comprising:
a source configured for emitting a stream of radiation;
a detector configured for detecting a portion of radiation and impacting a detecting face of the detector; and
a collision avoidance array disposed on the detecting face of the detector and configured for sensing objects.

2. The system of claim 1, wherein the collision avoidance array includes:
a plurality of plates disposed on the array substantially in a plane to form an array of capacitors, each plate configured to sense objects at a corresponding critical distance and configured to generate a corresponding electrical signal;
a plurality of conductors extending substantially in the plane and coupled to a multiplexer, each conductor being coupled to a corresponding one of the plurality of plates and configured for conducting the electrical signal to a sensing circuit via the multiplexer.

3. The system of claim 2, wherein the multiplexer is configured to selectively couple the plurality of plates to the sensing circuit.

4. The system of claim 3, wherein at least one conductor is coupled to ground to provide shielding for at least one of the plurality of conductors.

5. The system of claim 2, wherein the collision avoidance array further includes at least one shielding conductor extending substantially in the plane and coupled to ground, the shielding conductor configured for providing shielding to at least one of the plurality of conductors.

6. The system of claim 1, further comprising the collision avoidance array disposed on a non-detecting face of the detector.

7. The system of claim 1, further comprising a motor controlling a motion of a gantry, wherein the motor is configured to stop the motion of the gantry when the object is detected.

8. The system of claim 7, further comprising an analysis module coupled to the sensing circuit, the analysis module configured to determine a size of the object detected by the collision avoidance array.

9. The system of claim 8, wherein the analysis module is configured to determine a distance of the object from the collision avoidance array.

10. A collision avoidance system for avoiding collision of a system component with an object, the system comprising:
a collision avoidance array disposed on a face of the system component, the collision avoidance array comprising a plurality of plates configured to detect a presence of objects and generate a corresponding electrical signal;
a multiplexer coupled to the collision avoidance array, the multiplexer configured to selectively activate the plurality of plates; and
a sensing circuit configured to sense the electrical signal and to generate an output signal representative of the presence of the object.

11. The collision avoidance system of claim 10, further comprising an analysis module coupled to the sensing circuit, the analysis module configured to determine a size of the object detected by the collision avoidance array.

12. The system of claim 10, wherein the system component is an X-ray detector.

13. The system of claim 12, wherein the collision avoidance array is disposed on a detecting face of the X-ray detector, the detecting face configured for receiving radiation.

14. The system of claim 10, wherein the collision avoidance array is configured to detect the object within a critical distance from the system component.

15. A detection system for detecting a presence of an object, the detection system comprising:
a plurality of sensors disposed on a substrate substantially in a plane, each of the plurality of sensors configured for detecting the presence of the object and generating a corresponding electrical signal;
a plurality of conductors extending substantially in the plane and coupled to a corresponding one of the plurality of sensors, each conductor configured to transmit the electrical signal when the object is detected.

16. The detection system of claim 15, wherein each of the plurality of sensors is configured for detecting an object at a corresponding critical distance.

17. The detection system of claim 16, wherein the critical distance for each one of the plurality of sensors is determined by a corresponding dimension of the sensor.

18. The detection system of claim 17, wherein the critical distance is a constant for each one of the plurality of sensors.

19. The detection system of claim 15, wherein the substrate comprises an insulator

20. The detection system of claim 15, wherein each of the plurality of sensors comprise a corresponding capacitor sensor.

21. The detection system of claim 15, wherein at least one of the plurality of conductors is coupled to ground to provide shielding for the plurality of conductors.

22. The detection system of claim 21, further comprising at least one shielding conductor to provide shielding for at least one of the plurality of conductors.

23. A method for avoiding collision of a system component with an object, the method comprising:
detecting a presence of the object within a critical distance from a face of the system component and generating a corresponding electrical signal;
generating an output signal representative of the presence of the object.

24. The method of claim 23, further comprising controlling the system component to prevent collision with the object.

25. The method of claim 23, further comprising determining a size of the object detected.

26. The method of claim 23, wherein the system component is an X-ray detector.

27. The method of claim 26, wherein the detecting comprises detecting from a detecting face of the detector, wherein the detecting face is configured for receiving radiation from an X-ray source.

28. The method of claim 27, further comprising detecting objects from a non-detecting face of the detector.

29. A system for avoiding collision of a system component with an object, the system comprising:
means for detecting a presence of the object within a critical distance from a face of the system component and generating a corresponding electrical signal;
means for generating an output signal representative of the presence of the object.

30. The system of claim 29, further comprising means for controlling the system component to prevent collision with the object.

31. The system of claim 29, further comprising, means for determining a size of the object detected.

32. The system of claim 29, wherein the system component is an X-ray detector.

33. The system of claim 32, wherein the means for detecting comprises means for detecting from a detecting face of the detector, wherein the detecting face is configured for receiving radiation from an X-ray source.
